(19) United States
(12) Patent Application Publication
(10) Pub. No.: US 2024/0048253 A1
(43) Pub. Date: Feb. 8, 2024

(54) BEAMFORMED RECEIVED SIGNAL STRENGTH INDICATOR (RSSI) FOR WIRELESS NETWORKS

(71) Applicant: Apple Inc., Cupertino, CA (US)

(72) Inventors: Jie CUI, San Jose, CA (US); Yang TANG, San Jose, CA (US); Huaning NIU, San Jose, CA (US); Qiming LI, Beijing (CN); Manasa RAGHAVAN, Sunnyvale, CA (US); Xiang CHEN, Campbell, CA (US); Dawei ZHANG, Saratoga, CA (US); Hong HE, San Jose, CA (US); Yushu ZHANG, Beijing (CN); Haitong SUN, Cupertino, CA (US)

(73) Assignee: Apple Inc., Cupertino, CA (US)

(21) Appl. No.: 17/440,603

(22) PCT Filed: Mar. 31, 2021
(86) PCT No.: PCT/CN2021/084320

§ 371 Date: Sep. 17, 2021

(51) Int. Cl. H04B 17/318; H04W 24/10; H04W 72/0446

(52) U.S. Cl. CPC H04B 17/318; H04W 24/10; H04W 72/0446

(57) ABSTRACT

Some aspects include an apparatus, method, and computer program product for beamforming to perform received signal strength indicator (RSSI) measurements in a 5G wireless communications system. This beamforming may apply to RSSI measurements in an unlicensed spectrum. In some aspects, user equipment (UE) may use beam sweeping to analyze multiple received beams and to determine an RSSI measurement. When using beam sweeping, network nodes may use scheduling and/or measurement restrictions to avoid data collisions. These restrictions may apply to multiple active serving cells. In some aspects, a UE may use beam selection to determine an RSSI measurement. For example, the UE may select one or more beams from a serving component carrier (CC). In some aspects, a network node may indicate to the UE which beams to use for the RSSI measurement. In some aspects, the UE may use a frequency domain resource to perform the RSSI measurement.

### BACKGROUND

### Field

Various aspects generally may relate to the field of wireless communications.

### SUMMARY

Some aspects of this disclosure include apparatuses and methods for configuring beamforming at a user equipment (UE) to measure and report a received signal strength Indicator (RSSI) measurement.

In some aspects, a method for using beam sweeping at a UE to measure and report a RSSI measurement may include configuring the UE to perform beam sweeping to measure RSSI samples. The method may include receiving, at the UE, a plurality of beams from a RAN node and sampling, by the UE, the plurality of beams according to the beam sweeping to generate RSSI samples. The method may include calculating, by the UE, an average RSSI measurement based on the RSSI samples from the beam sweeping. The method may include transmitting, from the UE to the RAN node, the average RSSI measurement.

In some aspects, to configure the UE, the method may further include receiving, at the UE, a configuration instruction from the RAN node to use the beam sweeping to generate the RSSI samples. In some aspects, the method may further include the average RSSI measurement being a single RSSI measurement for the plurality of beams. In some aspects, the method may further include the average RSSI measurement comprises respective RSSI measurements for at least two of the plurality of beams. In some aspects, the method may further include the average RSSI measurement comprises respective RSSI measurements that exceed a predefined threshold. In some aspects, the plurality of beams includes a beam having a frequency between or above 52.6 GHz to 71 GHz.

In some aspects, a method for applying a scheduling restriction or a measurement restriction to allocate a time window for RSSI measurement may establishing, at a RAN node, a connection with a UE to receive a RSSI measurement. The method may include applying a scheduling restriction or a measurement restriction to communications with the UE to allocate a time window for the RSSI measurement. To apply the scheduling restriction, the method may further include establishing a connection with the UE via a first serving cell serviced by the RAN node and a second serving cell. The method may further include applying a scheduling restriction on transmitting data on a data channel and a control channel of the first serving cell during a time window allocated for RSSI measurement. The method may further include determining that the second serving cell is in a common beam management (CBM) band pair with the first serving cell or is a same band as the first serving cell. The method may further include applying the scheduling restriction to the second serving cell to prevent the second serving cell from transmitting data on a data channel and a control channel of the second serving cell during the time window allocated for RSSI measurement. The method may include receiving, from the UE, the RSSI measurement.

In some aspects, the method may further include identifying a first time window allocated for RSSI measurement at the UE and identifying a second time window corresponding to a layer measurement window for a Layer 1 (L1) or Layer 3 (L3) measurement. The method may further include determining that the first time window overlaps with the second time window and scheduling the first time window allocated for RSSI measurement to follow the second time window corresponding to the layer measurement window.

In some aspects, the method may further include identifying a first time window allocated for RSSI measurement at the UE and identifying a second time window corresponding to a layer measurement window for a Layer 1 (L1) or Layer 3 (L3) measurement. The method may further include determining that the first time window overlaps with the second time window and comparing a periodicity of the first time window to a periodicity of the second time window. The method may further include determining that the periodicity of the first time window is less than the periodicity of the second time window. The method may further include transmitting, from the RAN node to the UE, an instruction to perform an RSSI measurement during a non-overlapped instance of the first time window allocated for RSSI measurement.

In some aspects, the method may further include identifying a first time window allocated for RSSI measurement at the UE and identifying a second time window corresponding to a layer measurement window for a Layer 1 (L1) or Layer 3 (L3) measurement. The method may further include determining that the first time window overlaps with the second time window and comparing a periodicity of the first time window to a periodicity of the second time window. The method may further include determining that the periodicity of the second time window is less than the periodicity of the first time window. The method may further include transmitting, from the RAN node to the UE, an instruction to perform a layer measurement during a non-overlapped instance of the second time window.

In some aspects, the method may further include identifying a first time window allocated for RSSI measurement at the UE and identifying a second time window corresponding to a layer measurement window for a Layer 1 (L1) or Layer 3 (L3) measurement. The method may further include determining that the first time window overlaps with the second time window and comparing a periodicity of the first time window to a periodicity of the second time window. The method may further include determining that the periodicity of the first time window matches the periodicity of the second time window. The method may further include causing the UE to perform an RSSI measurement using a proportion of a plurality of overlapping first and second time windows.

In some aspects, the method may include the proportion of overlapping first and second time windows allocated for RSSI measurement being less than a proportion of overlapping first and second time windows allocated for layer measurement. In some aspects, the method may include the proportion of overlapping first and second time windows allocated for RSSI measurement being greater than a proportion of overlapping first and second time windows allocated for layer measurement.

In some aspects, a wireless communication apparatus may use beam sweeping to measure and report a RSSI measurement. The wireless communication apparatus may comprise a transceiver and at least one processor coupled to the transceiver. The at least one processor may be configured to receive a plurality of beams from a Radio Access Network (RAN) node. The at least one processor may be configured to sample the plurality of beams according to a beam sweeping process to measure received signal strength indicator (RSSI) samples. The at least one processor may be configured to calculate an average RSSI measurement based on the RSSI samples from the beam sweeping. The at least one processor may be configured to transmit, to the RAN node, the average RSSI measurement.

In some aspects, a wireless communication apparatus may use beam selection to measure and report a RSSI measurement. The wireless communication apparatus may comprise a transceiver and at least one processor coupled to the transceiver. The at least one processor may be configured to receive a plurality of beams from a Radio Access Network (RAN) node. The at least one processor may be configured to select one or more beams from the plurality of beams for sampling and sample the one or more beams selected to generate RSSI samples. The at least one processor may be configured to calculate an average RSSI measurement based on the RSSI samples from the one or more beams selected and to transmit, to the RAN node, the average RSSI measurement.

In some aspects, the at least one processor of the wireless communication apparatus may be further configured configure the wireless communication apparatus according to instructions stored in a memory device of the wireless communication apparatus to use a beam selection process to identify a subset of beams from the plurality of beams for sampling. In some aspects, the one or more beams selected by UE 110 may include a data channel reception beam, a control channel reception beam, an active TCI beam, an on-use active TC beam corresponding to a data channel, a highest priority signal, or a channel reception beam. In some aspects, the selected one or more beams may include a downlink reference signal beam. In some aspects, the selected one or more beams may include a random beam or a beam previously used for RSSI measurement.

In some aspects, a wireless communication apparatus may use one or more beams indicated by a RAN node to measure and report a RSSI measurement. The wireless communication apparatus may comprise a transceiver and at least one processor coupled to the transceiver. The at least one processor may be configured to receive an instruction from the RAN node indicating one or more beams for measuring RSSI samples. The at least one processor may be configured to receive a plurality of beams from the RAN node. The at least one processor may be configured to select the one or more beams indicated by the RAN node from the plurality of beams for sampling. The at least one processor may be configured to sample the one or more beams selected to generate RSSI samples. The at least one processor may be configured to calculate an average RSSI measurement based on the RSSI samples from the one or more beams indicated by the RAN node. The at least one processor may be configured to transmit, to the RAN node, the average RSSI measurement.

In some aspects, the indicated one or more beams may include a downlink reference signal beam or an uplink reference signal beam. In some aspects, the indicated one or more beams may include an active or inactive transmission configuration indicator (TCI) beam.

In some aspects, a wireless communication apparatus may use a frequency domain resource to measure and report a RSSI measurement. The wireless communication apparatus may comprise a transceiver and at least one processor coupled to the transceiver. The at least one processor may be configured to sample a channel bandwidth one or more bandwidth parts, a transmission bandwidth, an uplink granted bandwidth, or a downlink granted bandwidth to generate RSSI samples. The at least one processor may be configured to calculate an average RSSI measurement based on the RSSI samples from the channel bandwidth, the one or more bandwidth parts, the transmission bandwidth, the uplink granted bandwidth, or the downlink granted bandwidth. The at least one processor may be configured to transmit, to a Radio Access Network (RAN) node, the average RSSI measurement.

In some aspects, the at least one processor of the wireless communication apparatus may be further configured to receive a configuration instruction from the RAN node identifying a RSSI measurement bandwidth, channel bandwidth, the one or more bandwidth parts, the transmission bandwidth, the uplink granted bandwidth, or the downlink granted bandwidth and instructing the wireless communication apparatus to use the RSSI measurement bandwidth, channel bandwidth, the one or more bandwidth parts, the transmission bandwidth, the uplink granted bandwidth, or the downlink granted bandwidth for RSSI measurement.

### BRIEF DESCRIPTION OF THE DRAWINGS/FIGURES

FIG. 1A illustrates an example system implementing beamforming for determining a received signal strength indicator (RSSI) measurement, according to some aspects.

FIG. 1B illustrates a block diagram of an example wireless system of an electronic device implementing beamforming for determining a RSSI measurement, according to some aspects.

FIG. 2 illustrates a flowchart for beam sweeping to determine a RSSI measurement at user equipment (UE), according to some aspects.

FIG. 3A illustrates a flowchart for applying a schedule restriction or a measurement restriction to allocate a time window for RSSI measurement, according to some aspects.

FIG. 3B illustrates a flowchart for determining a schedule restriction when beam sweeping is used to determine a RSSI measurement, according to some aspects.

FIG. 3C illustrates a flowchart for determining a measurement prioritization when beam sweeping is used to determine a RSSI measurement, according to some aspects.

FIG. 3D illustrates a flowchart for determining measurement prioritization based on periodicity when beam sweeping is used to determine a RSSI measurement, according to some aspects.

FIG. 3E illustrates a flowchart for determining measurement prioritization with matching periodicity when beam sweeping is used to determine a RSSI measurement, according to some aspects.

FIG. 4A illustrates a block diagram of overlapping periodicities with an RSSI window having a lower periodicity, according to some aspects.

FIG. 4B illustrates a block diagram of overlapping periodicities with a layer measurement window having a lower periodicity, according to some aspects.

FIG. 4C illustrates a block diagram of matching periodicities, according to some aspects.

FIG. 5 illustrates a flowchart for beam selection to determine a RSSI measurement at a UE, according to some aspects.

FIG. 6 illustrates a flowchart for beam indication to determine a RSSI measurement at a UE, according to some aspects.

FIG. 7 illustrates a flowchart for using a frequency domain resource to determine a RSSI measurement at a UE, according to some aspects.

FIG. 8 depicts an example computer system useful for implementing various aspects.

The features and advantages of the aspects will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various aspects. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B).

This disclosure relates to user equipment (UE) communications using the various wireless communications protocols developed by the 3rd Generation Partnership Project (3GPP), including Release 15 (Rel-15), Release 16 (Rel-16), and Release 17 (Rel-17), of which one or more are related to the 5G wireless protocol standard (e.g., 5G).

As developments continue with subsequent releases of the 5G standard and beyond, one consideration that remains is how beamforming should be used for measuring a received signal strength indicator (RSSI) at a UE communicating with a base station. An RSSI measurement may be a value determined by the UE indicating the strength of a signal received from the base station. The RSSI may reflect a measurement of total power received over a bandwidth by the UE. In some aspects, the RSSI may be a linear average of the total received power. The RSSI may be expressed in Watts and/or decibel-milliwatts (dBm). In some aspects, the RSSI may reflect the received power observed by the UE for particular orthogonal frequency-division multiplexing (OFDM) symbols of measured time resources. The RSSI measurement may indicate the power for a measured bandwidth. The RSSI measurement may account for signal interference. For example, the RSSI measurement may be an additive value reflecting received serving cell power, neighboring co-channel cell power, and/or thermal noise.

A UE may determine an RSSI measurement and report this RSSI measurement to a base station and/or to the network. This reporting may help the network with determining cell selection, cell reselection, and/or handovers. For example, a UE may be located between two or more cells. Depending on the RSSI measurement and/or other values such as Reference Signal Received Power (RSRP) and/or Reference Signal Received Quality (RSRQ), the network may determine a cell or base station to service the UE.

As communication protocols continue to develop into higher frequencies, questions regarding RSSI measurement still remain. These frequencies may be in the range between or above 52.6 GHz to 71 GHz. In some cases, this may be an unlicensed spectrum. To measure a RSSI value at these frequencies or at this spectrum for 5G New Radio Unlicensed (NR-U), this disclosure describes the use of beamforming at the UE to determine a RSSI measurement. This disclosure also describes network behavior and/or potential scheduling and/or measurement restrictions based on the beamforming. For example, these restrictions may occur when a received RSSI beam differs from a received data or control beam or from a downlink reference signal (DL RS) beam.

As will be further explained below, the beamforming techniques of beam sweeping, beam selection, and/or beam indication may be used to configure a UE to determine an RSSI measurement. In some aspects, the UE may use a frequency domain resource to perform an RSSI measurement. When using these techniques, the network may restrict some transmissions on data and/or control channels to avoid collisions with RSSI measurement windows.

Various aspects of these features will now be discussed with respect to the corresponding figures.

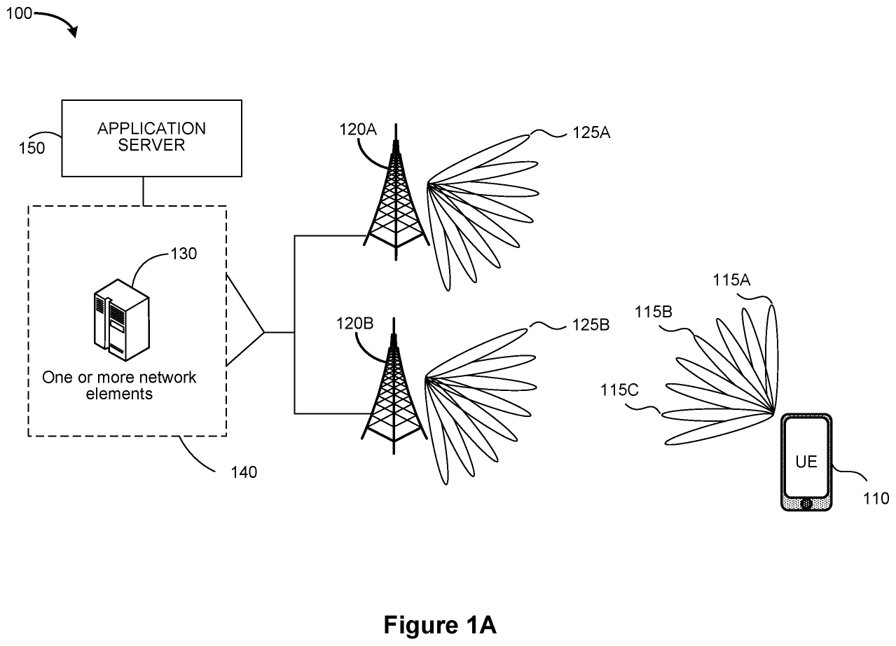

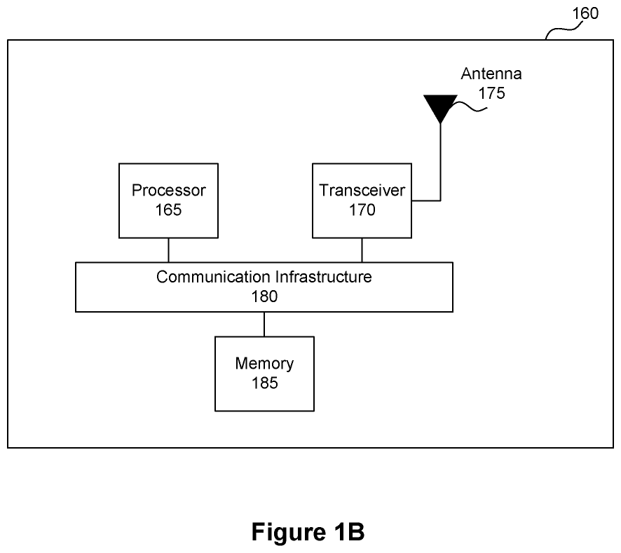

FIG. 1A illustrates an example system 100 implementing beamforming for determining a received signal strength indicator (RSSI) measurement, according to some aspects. FIG. 1A illustrates an example system architecture 100 of a network, in accordance with various aspects. The following description is provided for an example system 100 that operates in conjunction with the LTE system standards and 5G or NR system standards as provided by 3GPP technical specifications. However, the example aspects are not limited in this regard and the described aspects may apply to other networks that benefit from the principles described herein, such as other 3GPP systems (e.g., Sixth Generation (6G)) systems. IEEE 802.16 protocols (e.g., WMAN, WiMAX, etc.), or the like.

As shown by FIG. 1A, the system 100 includes UE 110. In this example, UE 110 is illustrated as a smartphone (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, and the like.

UE 110 may be configured to connect, for example, communicatively coupled, with a Radio Access Network (RAN) including RAN nodes 120A, 120B. A RAN node 120 may also be referred to as a base station (BS). In aspects, the RAN may be an NG RAN or a 5G RAN, an E-UTRAN, or a legacy RAN, such as a UTRAN or GERAN. As used herein, the term “NG RAN” or “next-generation RAN” or the like may refer to a RAN that operates in an NR or 5G system 100, and the term “E-UTRAN” or the like may refer to a RAN that operates in an LTE or 4G system 100. The UE 110 may utilize connections (or channels), each of which comprises a physical communications interface or layer (discussed in further detail below). In some aspects, UE 110 may communicate with one or more RAN nodes 120.

RAN nodes 120 are shown to be communicatively coupled to a core network—in this aspect, core network (CN) 140. The CN 140 may comprise a plurality of network elements 130, which are configured to offer various data and telecommunications services to customers/subscribers (e.g., a user of UE 110) who are connected to the CN 140 via the RAN nodes 120.

Generally, the application server 150 may be an element offering applications that use IP bearer resources with the core network (e.g., UMTS PS domain, LTE PS data services, etc.). The application server 150 can also be configured to support one or more communication services (e.g., VoIP sessions. PTT sessions, group communication sessions, social networking services, etc.) for the UE 110 via the CN 140.

To perform RSSI measurement, UE 110 may identify local received beams 115A, 115B, 115C for sampling and/or measurement. The local received beams 115 received at UE 110 may correspond to beams 125A, 125B transmitted by RAN nodes 120A, 120B respectively. In some aspects, beams 125A, 125B may be a plurality of beams which include a beam 125 having a frequency between or above 52.6 GHz to 71 GHz. To synchronize the local received beams 115 received at UE 110 with beams 125A, 125B, RAN nodes 120A, 120B may transmit beams 125A, 125B in predefined directions. As will be further explained below, UE 110 may perform beam sweeping, beam selection, and/or may use one or more beams 115 indicated by a RAN node 120 to determine a RSSI measurement. In some aspects, UE 110 may determine a frequency domain resource to perform the RSSI measurement.

After UE 110 determines an RSSI measurement, UE 110 may report this RSSI measurement to RAN node 120A and/or 120B. RAN node 120A and/or 120B may provide the RSSI measurement to CN 140 and/or application server 150. CN 140 and/or application server 150 may then determine one or more cells to service communications for UE 110. In some aspects, a node of CN 140 and/or RAN nodes 120A, 120B may determine a cell for communications. RAN nodes 120A and 120B may service respective cells.

As will be further described below, RAN nodes 120A and/or 120B may perform scheduling restrictions based on the active cell where the RSSI measurement is performed. These scheduling restrictions may aid in preventing collisions with other measurements, such as, for example, Layer 1 (L1) or Layer 3 (L3) measurements. These scheduling restrictions may apply to a target serving cell and/or to other active serving cells. For example, RAN node 120A may be a target serving cell, which may be an active serving cell where the RSSI measurement is performed. RAN node 120B may be another active serving cell performing another measurement, such as an L1 or L3 measurement.

FIG. 1B illustrates a block diagram of an example wireless system 160 of an electronic device implementing beamforming for determining a RSSI measurement, according to some aspects. As a convenience and not a limitation, system 160, may be described with elements of FIG. 1A. System 160 can be UE 110 or RAN nodes 120 of FIG. 1A. System 160 may include processor 165, transceiver 170, communication infrastructure 180, memory 185, and antenna 175 that together facilitate RSSI measurement. Transceiver 170 transmits and receives 5G wireless communications signals via antenna 175. Communication infrastructure 180 may be a bus. Memory 185 may include random access memory (RAM) and/or cache, and may include control logic (e.g., computer software), computer instructions, and/or data. Processer 165, upon execution of the computer instructions, may be configured to perform the functionality described herein for RSSI measurement. Alternatively, processor 165 can include its own internal memory (not shown), and/or be “hard-wired” (as in a state-machine) configured to perform the functionality described herein for RSSI measurement. Antenna 175 coupled to transceiver 170, may include one or more antennas, antenna arrays, and/or panels (not shown) that may be the same or different types to enable wireless communication over a wireless network.

In some aspects, UE 110 may utilize the components of wireless system 160. According to some aspects, processor 165, alone or in combination with memory 185, and/or transceiver 170, implements the beamforming for RSSI measurement. As further explained below, UE 110 may be configured to perform beam sweeping, beam selection, and/or to use indicated beams to determine an RSSI measurement. These beams may be received via antenna 175 and/or transceiver 170. In some aspects, UE 110 may determine a frequency domain resource to perform the RSSI measurement. UE 110 may similarly use signals received via antenna 175 and/or transceiver 170 for specified bandwidths and/or bandwidth parts to perform the RSSI measurement. In some aspects, processor 165 may be configured to perform the RSSI measurement according to a pre-configured beamforming and/or frequency domain process. In some aspects, UE 110 may receive an instruction from a RAN node 120 via antenna 175 and/or transceiver 170 to use a particular beamforming and/or frequency domain process for the RSSI measurement.

Using antenna 175 and/or transceiver 170, UE 110 may receive one or more beams transmitted from a RAN node 120. Based on the beamforming configuration of UE 110, UE 110 may sample the received one or more beams to identify RSSI samples. UE 110 may then calculate an average RSSI measurement using the RSSI samples. This calculation may occur at processor 165 and may occur according to the beamforming configuration. For example, when beam sweeping is used, UE 110 may calculate an average RSSI measurement across multiple received beams. When beam selection is used, UE 110 may calculate an average RSSI measurement across the selected beams. In some aspects, UE 110 may calculate an average RSSI measurement for each selected beam. UE 110 may select the beams when using beam selection. When using beam indication. UE 110 may receive an indication from a RAN node 120 of one or more beams to use for an RSSI measurement. UE 110 may determine an RSSI measurement across the one or more beams indicated and/or for each of the one or more beams indicated. In some aspects, UE 110 may determine a channel bandwidth and/or may identify bandwidth parts to use for an RSSI measurement.

After determining an RSSI measurement, UE 110 may report the RSSI measurement to a RAN node 120. Processor 165 may transmit the RSSI measurement to RAN node 120 via transceiver 170 and/or antenna 175. RAN node 120 may receive the RSSI measurement and may determine cell selection using the RSSI measurement.

In some aspects, a RAN node 120 may utilize the components of wireless system 160. According to some aspects, RAN node 120 may transmit a configuration instruction to UE 110 using transceiver 170 and/or antenna 175. This configuration instruction may indicate a type of beamforming for the UE 110 to use. For example, this configuration instruction may instruct UE 110 to use beam sweeping and/or beam selection. In some aspects. RAN node 120 may transmit a configuration instruction indicating one or more beams to the UE 110 to use for determining an RSSI measurement.

RAN node 120 may transmit one or more beams 125 using transceiver 170 and/or antenna 175 for UE 110 to use to determine an RSSI measurement. As previously explained, UE 110 may sample these received beams 115 to determine an RSSI measurement. UE may then report the RSSI measurement back to RAN node 120. RAN node 120 may receive the RSSI measurement report via transceiver 170 and/or antenna 175.

As further explained below, RAN node 120 may determine scheduling restrictions to prevent collisions of data from occurring at UE 110. RAN node 120 may determine the scheduling restrictions at processor 165. The scheduling restrictions may prevent data from being transmitted on a data and/or control channel during an RSSI measurement window. This RSSI measurement window may be a window of time allocated for UE 110 to perform a RSSI measurement. During this time, data is restricted from being transmitted to UE 110 because UE 110 may be busy performing the RSSI measurement.

In some aspects, RAN node 120A may also schedule an RSSI measurement window to avoid collisions with other measurement windows scheduled and/or performed by RAN node 120B. In some aspects, another node from CN 140 may perform the scheduling between RAN node 120A and 120B. For example, as will be described further below, RAN node 120A may be a target serving cell performing the RSSI measurement. RAN node 120B may be performing a Layer 3 (L3) measurement and/or a Layer 1 (L1) measurement. The L1 measurement may include other beam management or measurement. To avoid collisions, RAN node 120A and/or 120B may determine a priority for the RSSI measurement along with the L3 or L1 measurement. As will be further discussed below, this priority may be based on a determined periodicity of the measurement time windows.

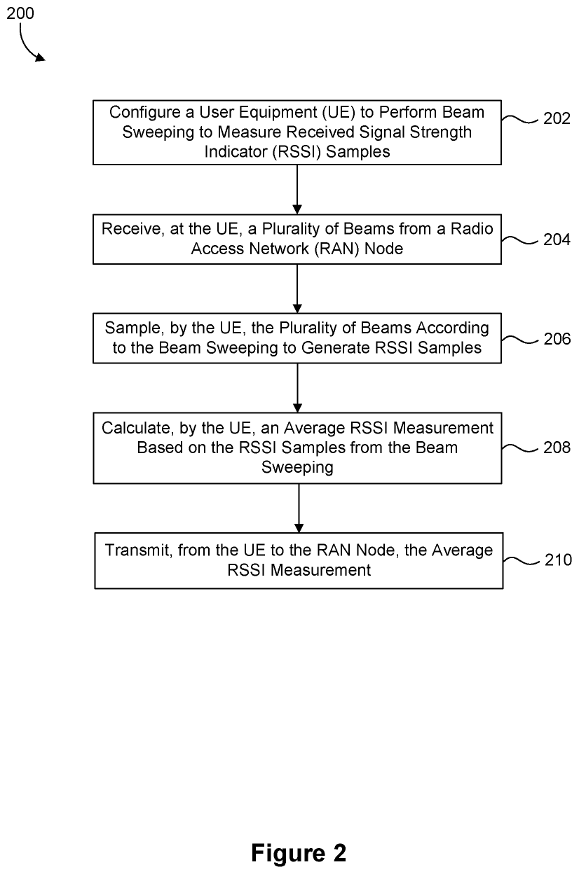

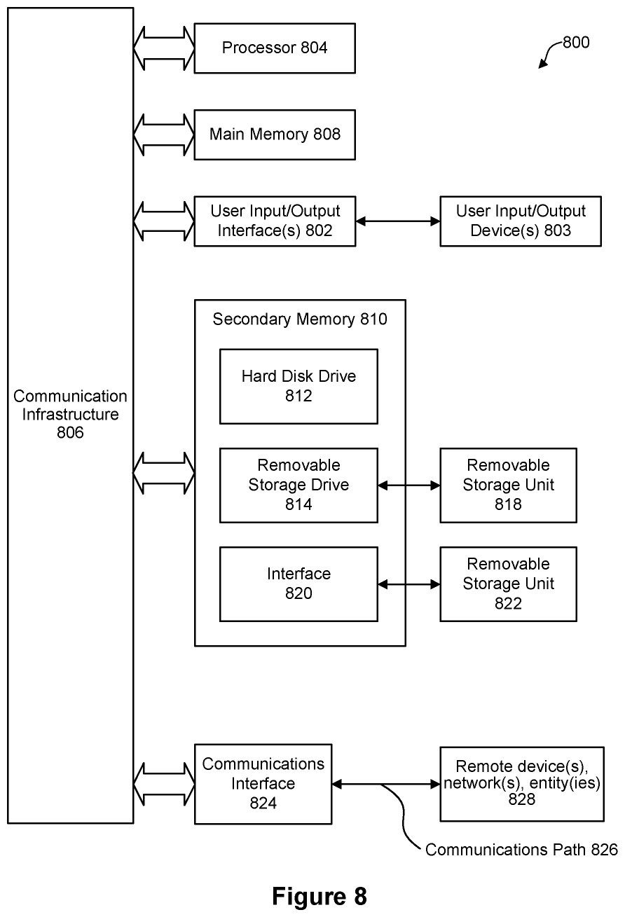

FIG. 2 illustrates a flowchart 200 for beam sweeping to determine a RSSI measurement at user equipment (UE), according to some aspects. In some aspects, UE 110 may execute flowchart 200. Flowchart 200 shall be described with reference to UE 110; however, flowchart 200 is not limited to that example aspect. Flowchart 200 may be implemented by processor 165 (FIG. 1B). For example, processor 165 may execute instructions, stored in memory 185, to perform the functions described in flowchart 200. Alternatively, processor 165 may be “hard-coded” to perform these functions. Additionally, flowchart 200 may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 2, as will be understood by a person of ordinary skill in the art.

At 202, UE 110 may be configured to perform beam sweeping to measure received signal strength indicator (RSSI) samples. For example, a processor 165 in UE 110 may be configured to perform a beam sweeping process to analyze received beams. This configuration may occur according to a predefined communications standard. For example, UE 110 may be preprogrammed to perform a beam sweeping process. Memory 185 may store executable instructions and/or software instructing processor 165 to use the beam sweeping process. In some aspects, a RAN node 120 may transmit a configuration instruction to UE 110 to configure UE 110 to perform the beam sweeping process. For example, the configuration instruction may provide and/or activate programming in UE 110 to perform a beam sweeping process to determine an RSSI measurement.

To perform the beam sweeping process, UE 110 may analyze multiple local received beams 115A, 115B, 115C. Local received beams 115A, 115B, 115C may correspond to beams 125A transmitted from a RAN node 120A, which may be transmitted in predefined directions. In some aspects, UE 110 may use all possible local received beams 115 for the RSSI measurement. In some aspects, the beam sweeping may occur from symbol to symbol, slot to slot, and/or from one RSSI measurement timing configuration (RMTC) window to another RMTC window. In some aspects, the local received beams 115A, 115B, 115C may be rough beams or fine beams. The beam sweeping process used by UE 110 may analyze the multiple local received beams 115A, 115B, 115C to determine the RSSI measurement. The configuration at 202 may occur prior to receiving a plurality of beams for performing an RSSI measurement.

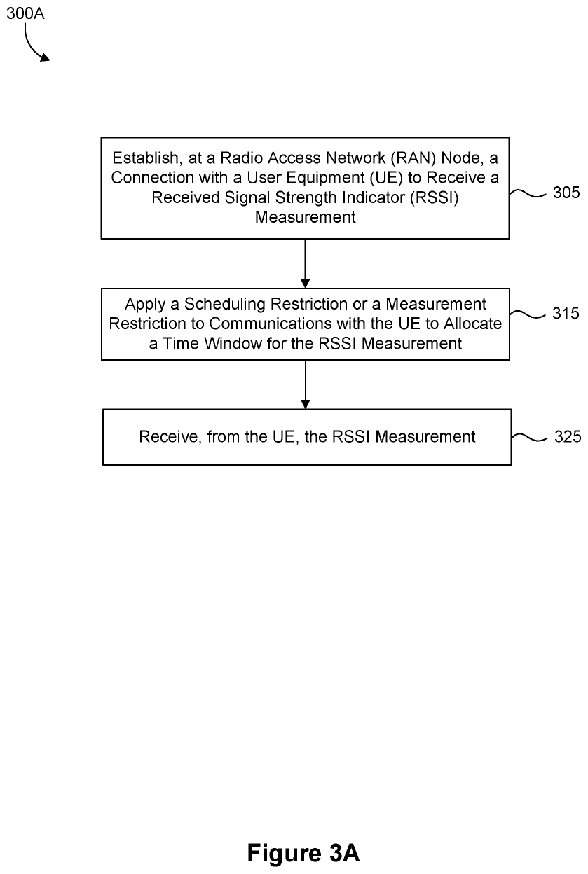

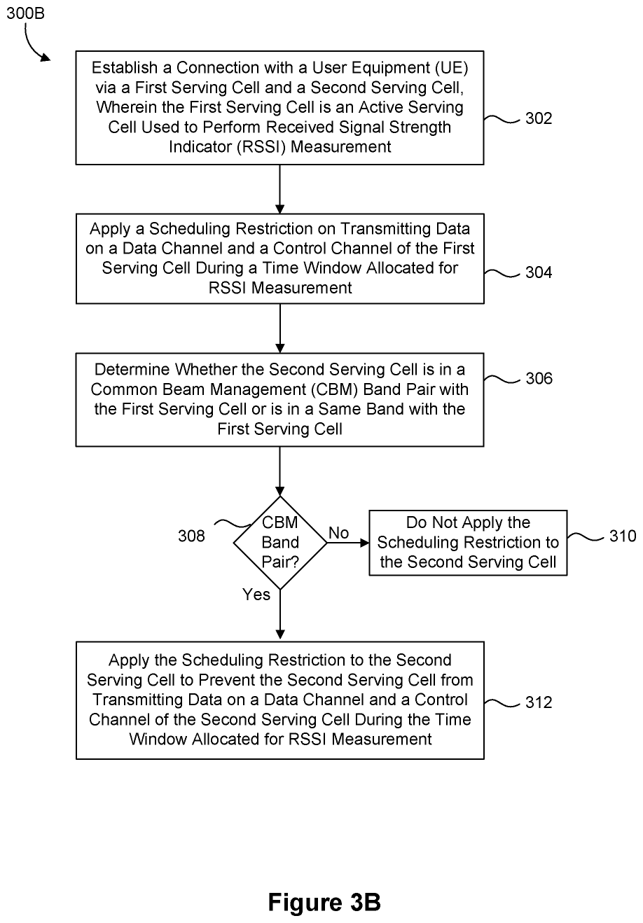

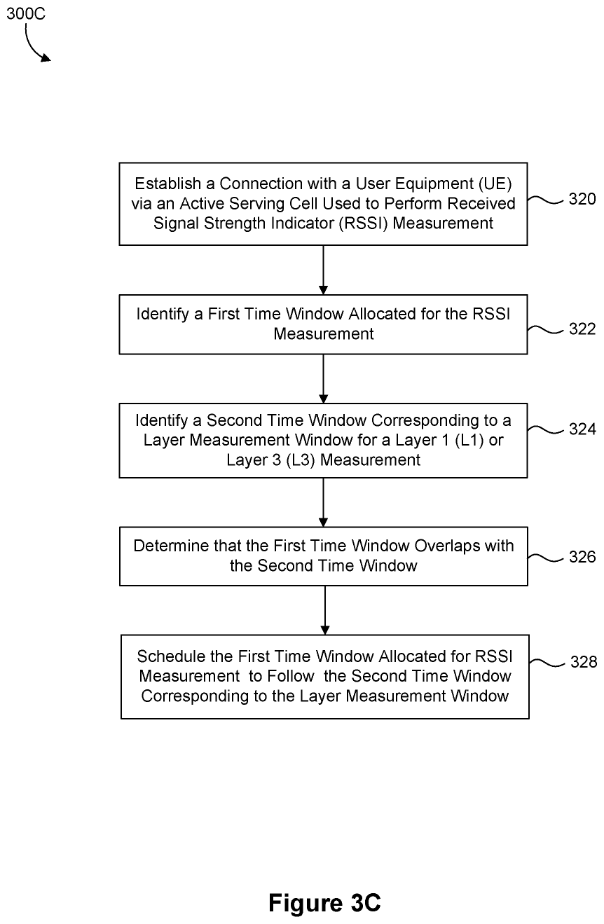

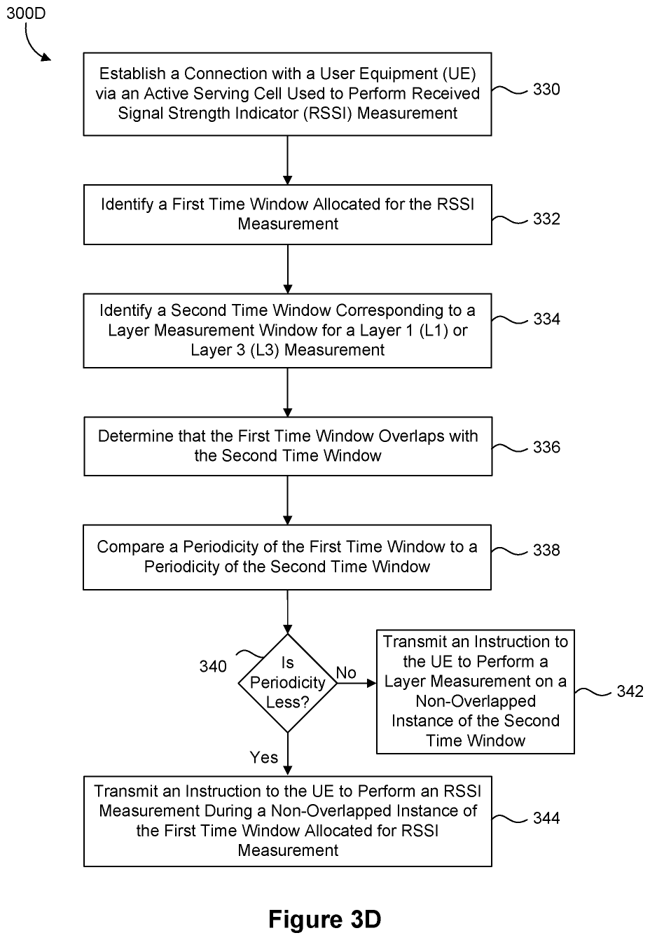

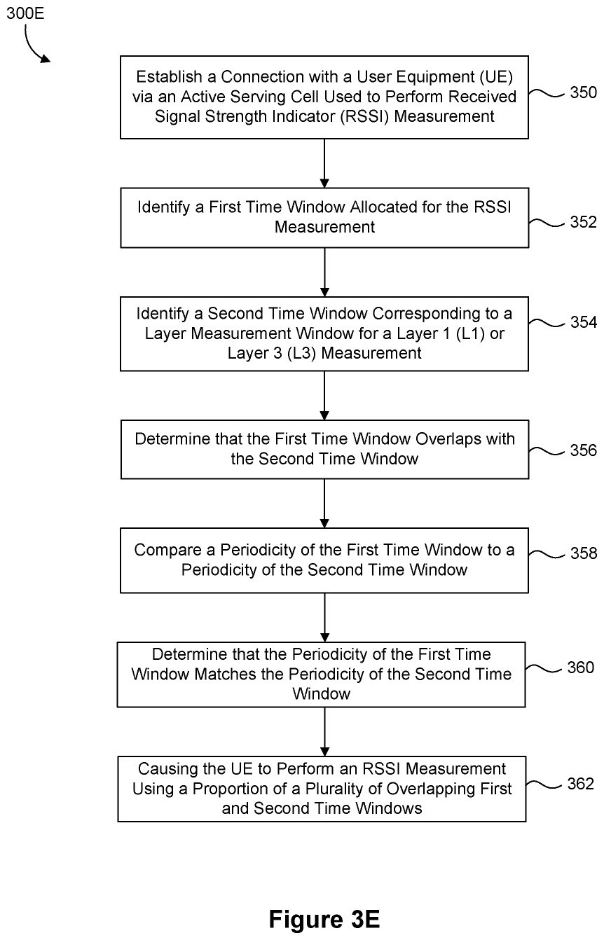

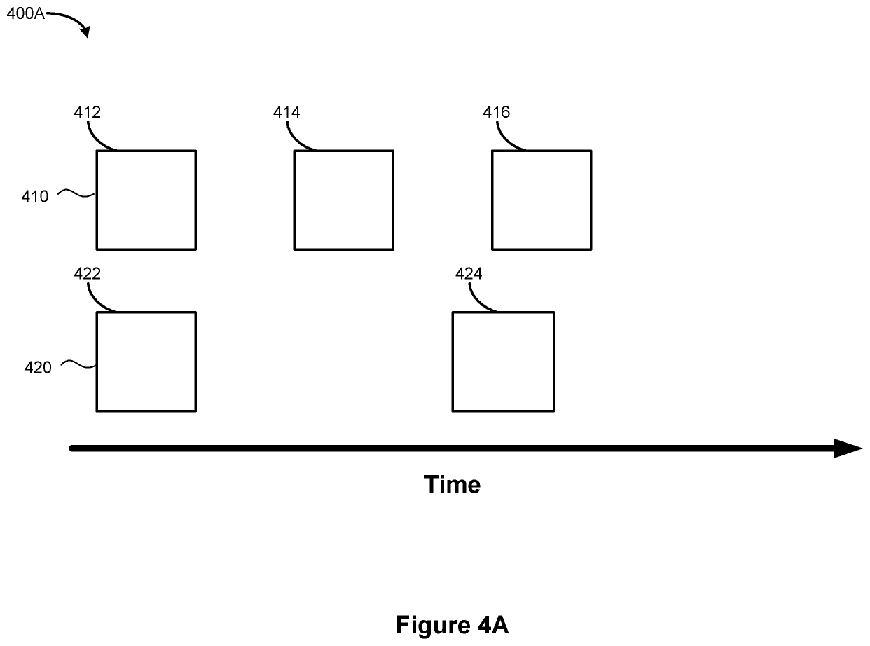

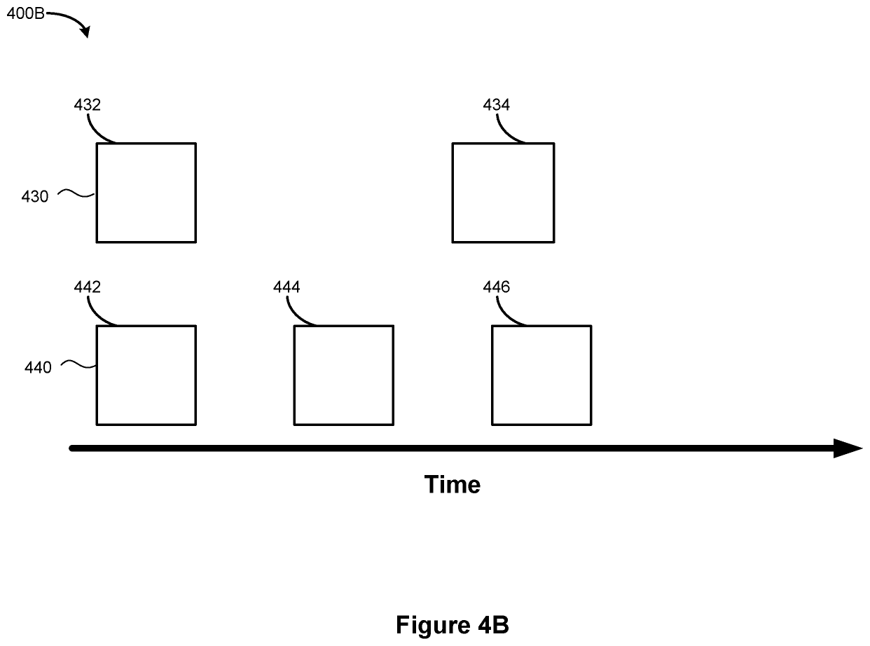

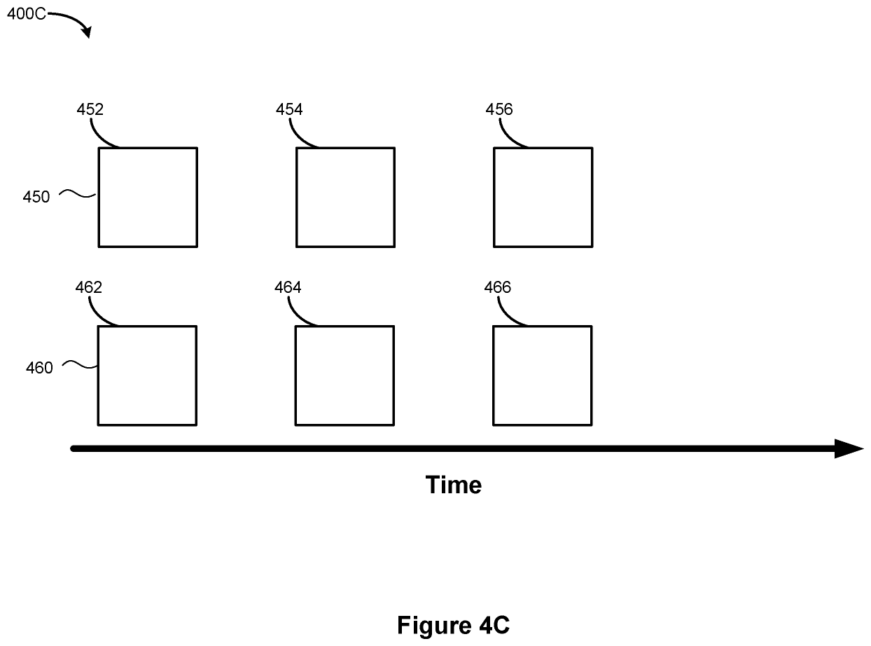

At 204, UE 110 may receive a plurality of beams from a Radio Access Network (RAN) node 120. For example, UE 110 may be communicating with RAN node 120A, which may service a target serving cell where the RSSI measurement is performed. In some aspects. UE 110 may receive multiple pluralities of beams 125A, 125B from multiple RAN nodes 120. For example, UE 110 may receive beams 125A, 125B from RAN nodes 120A and 120B. Using beam sweeping, UE 110 may analyze these received beams 125A, 125B. To identify the beams 125 allocated for RSSI measurement, however, RAN nodes 120A and 120B may schedule transmissions to avoid collisions. Processes for this scheduling and prioritization are further described with reference to FIGS. 3A, 3B, 3C, 3D, 3E, 4A, 4B, and 4C. With this scheduling, UE 110 may perform beam sweeping on the multiple local received beams 115A, 115B, 115C and avoid potential collisions with data transfers and/or other measurements.

At 206, UE 110 may sample the plurality of beams according to the beam sweeping to generate RSSI samples. These beams may be the multiple local received beams 115A, 115B, 115C. The samples may be generated on a per beam basis. Depending on the configuration from 202, the samples may be multiple samples and/or may be a single sample if a one shot RSSI measurement is used. For example, UE 110 may measure one RSSI measurement on each of the local received beams 115A, 115B, 115C. In some aspects. UE 110 may identify multiple samples per beam. The determination of the sampling may be based on the configuration as described in 202. The RAN node 120 used to perform the RSSI measurement may also be configured to provide the corresponding beams 125A, 125B to correlate with the sampling performed by UE 110.

At 208, UE 110 may calculate an average RSSI measurement based on the RSSI samples from the beam sweeping. The average RSSI measurement may be a single value or may be multiple values corresponding to different beams. In some aspects, the calculated average RSSI measurement may depend on the configuration performed at 202. This calculated average may be preconfigured at UE 110 and/or may be requested by a RAN node 120. In some aspects, the calculated average may be determined by performing Layer 1 (L1) filtering on the RSSI samples.

In some aspects, the calculated average may be determined across the plurality of beams 115. For example, UE 110 may calculate an RSSI measurement by averaging the samples across the plurality of beams 115. If a one shot RSSI measurement is used, UE 110 may identify the single RSSI sample measured for each beam and then average together or L1 filter the samples from each beam.

The RSSI measurement may be multiple values corresponding to calculated averages from RSSI samples received on different beams 115A, 115B. For example, UE 110 may calculate a first RSSI measurement for beam 115A based on RSSI samples received on beam 115A. UE 110 may calculate a second RSSI measurement for beam 115B based on RSSI samples received on beam 115B. The average RSSI measurement may be respective RSSI measurements for at least two or more of the plurality of beams. If a one shot RSSI measurement is used, the calculated average for each beam 115A, 115B may be the single RSSI sample measured for each beam.

At 210, UE 110 may transmit the average RSSI measurement to a RAN node 120. As previously explained, the calculated average RSSI measurement may depend on the configuration specified at 202. The reporting to RAN node 120 may also depend on this configuration. In some aspects, UE 110 may report a single RSSI measurement result. This result may correspond to averaging the RSSI beam samples across the plurality of beams. In some aspects, UE 110 may report multiple RSSI measurement results corresponding to one or more of the plurality of beams. For example, UE 110 may report a RSSI measurement for beam 115A and/or another RSSI measurement for beam 115B. In some aspects, UE 110 may report a corresponding beam number and/or identification corresponding to each RSSI measurement. These RSSI measurements may occur for each of the beams transmitted by RAN node 120 and/or may be a subset of the beams transmitted.

In some aspects, UE 110 may report one or more RSSI measurements that exceed a threshold. The threshold may be predefined. The UE 110 may report only the RSSI measurements corresponding to the top or strongest beams 115. UE 110 may compare each RSSI measurement for each beam 115 to the threshold and transmit the RSSI measurements exceeding the threshold. In some aspects, UE 110 may report a corresponding beam number and/or identification corresponding to each RSSI measurement exceeding the threshold. The RSSI measurements reported may correspond to a subset of the beams 115 received by UE 110.

Based on the reported RSSI measurements, RAN nodes 120 may determine cell selection for UE 110. To aid with this determination, as previously explained at 202, one or more RAN nodes 120 may transmit configuration instructions to UE 110 to indicate the type of sampling to perform, the type of average RSSI measurement to calculate, and/or the type of RSSI measurement results to report. For example, in the RSSI mobile originating configuration, the RAN node 120 may configure the RSSI measurement to use beam sweeping. The RAN node 120 may instruct UE 110 to perform averaging or L1 filtering for each received beam. In some aspects, the RAN node 120 may instruct UE 110 to perform averaging or L1 filtering based on the total of the received beams.

RAN nodes 120 may also instruct a UE 110 to report one or more RSSI measurements. For example, UE 110 may be instructed to provide a single RSSI measurement result. In some aspects, UE 110 may be instructed to report individual RSSI measurement results corresponding to one or more beams or for each beam. In some aspects, UE 110 may be instructed to use a threshold to determine which RSSI measurement results to report. For example, UE 110 may report RSSI measurements exceeding the threshold and/or corresponding beam identifications. In some aspects, UE 110 may report one reference RSSI measurement result and delta values of other RSSI measurement results compared to the reported one reference RSSI measurement.

RAN nodes 120 will be further described with reference to FIGS. 3A, 3B, 3C, 3D, and 3E. These figures describe operations at RAN nodes 120 when UE 110 uses beam sweeping. These processes describe applying scheduling restrictions, measurement restrictions, and/or time window prioritizations to avoid data transmission and/or measurement collisions. For example, a RAN node 120A may apply a scheduling restriction to prevent the transmission of data on a data or control channel during the RSSI measurement window. RAN node 120A may be the target and/or active serving cell where the RSSI measurement is performed. As will be further described below, this scheduling restriction may also be applied to another active serving cell, such as RAN node 120B, if the other active serving cell is in a common beam management (CBM) band pair with the target active serving cell (i.e., RAN node 120A). If another active serving cell is in an independent beam management (IBM) band pair, the scheduling restriction may not be applied to the other active serving cell. FIGS. 3A, 3B, 3C. 3D, and 3E describe further operations for prioritizing Layer 3 (L3) and Layer 1 (L1) measurements to avoid collisions with RSSI measurements. These scheduling and measurement prioritization may be applicable within a serving cell such as RAN node 120A and/or between serving cells such as RAN nodes 120A and 120B. In some aspects, as will be further described below, the processes described with reference to FIGS. 3A, 3B, 3C, 3D, and 3E may also apply when a UE uses a beam selection and/or beam indication process to determine an RSSI measurement.

FIG. 3A illustrates a flowchart 300A for applying a schedule restriction or a measurement restriction to allocate a time window for RSSI measurement, according to some aspects. In some aspects, CN 140 and/or one or more RAN nodes 120 may execute flowchart 300A. For example, RAN nodes 120A. 120B may execute flowchart 300A. In some aspects, application server 150 and/or CN 140 may operate with RAN nodes 120A, 120B to execute flowchart 300A. Flowchart 300A shall be described with reference to RAN node 120A; however, flowchart 300A is not limited to that example aspect. Flowchart 300A may be implemented by processor 165 (FIG. 1B). For example, processor 165 may execute instructions, stored in memory 185, to perform the functions described in flowchart 300A. Alternatively, processor 165 may be “hard-coded” to perform these functions. Additionally, flowchart 300A may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3A, as will be understood by a person of ordinary skill in the art.

At 305, RAN node 120A may establish a connection with a UE 110 to receive a RSSI measurement. UE 110 may provide the RSSI measurement to RAN node 120A. As previously explained, the RSSI measurement may be used by RAN node 120A to determine a cell for servicing UE 110. As will be further explained, in some aspects, RAN node 120A may provide configuration instructions to UE 110 regarding a specific protocol or process to use to determine the RSSI measurement. RAN node 120A may also specify the type and/or format of the RSSI measurement to be received from UE 110.

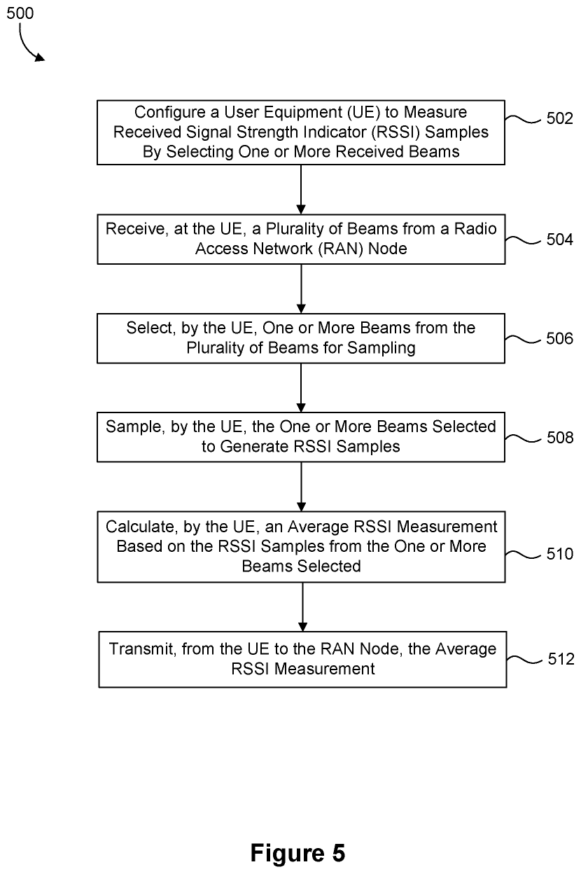

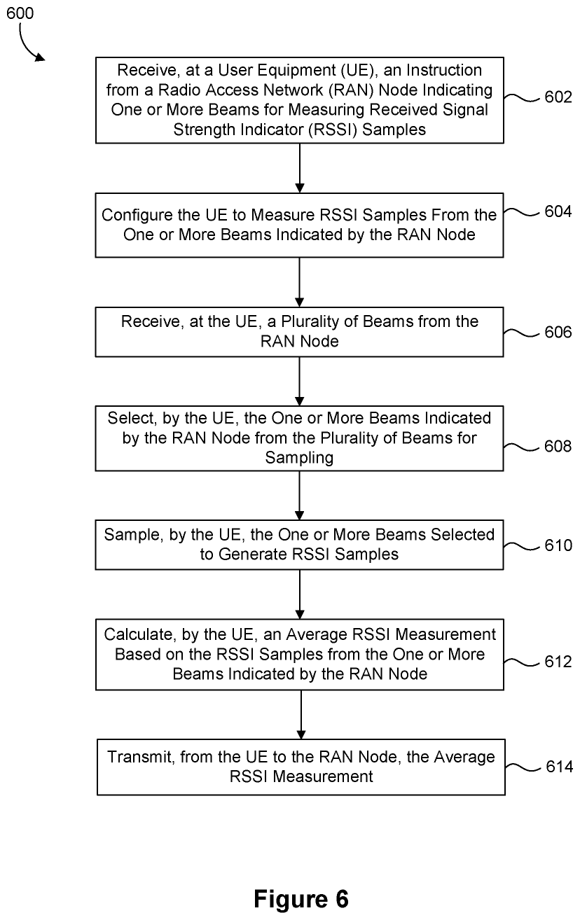

At 315, RAN node 120A may apply a scheduling restriction or a measurement restriction to communications with the UE 110 to allocate a time window for the RSSI measurement. As will be further describe with reference to FIGS. 3B to 3E, these restrictions may aid in avoiding data collisions while the UE 110 performs an RSSI measurement. In some aspects, the scheduling and/or measurement restrictions may apply to one or more RAN nodes 120A, 120B servicing UE 110. In some aspects, while FIGS. 3B to 3E may be described with reference to beam sweeping, RAN node 120A may apply these processes when UE 110 uses beam selection and/or when RAN node 120A indicates a beam to use for RSSI measurement. These processes will be further described with reference to FIGS. 5 and 6.

At 325, RAN node 120A may receive, from UE 110, the RSSI measurement. This RSSI measurement may be requested by RAN node 120A. In some aspects, RAN node 120A may specify the format or type of the RSSI measurement to the UE 110. In some aspects, a predefined protocol may be used. In this case, UE 110 may executed instructions and/or software stored in memory to determine the format and type of RSSI measurement to report.

FIG. 3B illustrates a flowchart 300B for determining a schedule restriction when beam sweeping is used to determine a RSSI measurement, according to some aspects. In some aspects, CN 140 and/or one or more RAN nodes 120 may execute flowchart 300B. For example, RAN nodes 120A, 120B may execute flowchart 300B. In some aspects, application server 150 and/or CN 140 may operate with RAN nodes 120A, 120B to execute flowchart 300B. Flowchart 300B shall be described with reference to RAN nodes 120A and 120B; however, flowchart 300B is not limited to that example aspect. Flowchart 300B may be implemented by processor 165 (FIG. 1B). For example, processor 165 may execute instructions, stored in memory 185, to perform the functions described in flowchart 300B. Alternatively, processor 165 may be “hard-coded” to perform these functions. Additionally, flowchart 300B may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3B, as will be understood by a person of ordinary skill in the art.

At 302, a connection with a UE 110 may be established via a first serving cell and a second serving cell. The first serving cell may be an active serving cell used to perform RSSI measurement. The first serving cell may be serviced by RAN node 120A while the second serving cell may be serviced by RAN node 120B. As previously explained, RAN nodes 120A, 120B may be nodes on network CN 140 and may connect to UE 110 to provide communication services.

At 304, RAN node 120A may apply a scheduling restriction on transmitting data on a data channel and a control channel of the first serving cell during a time window allocated for RSSI measurement. This scheduling restriction may prevent RAN node 120A from transmitting data during a time window allocated for UE 110 to perform the RSSI measurement.

At 306, RAN node 120A may determine whether the second serving cell is in a common beam management (CBM) band pair with the first serving cell or is in a same band as the first serving cell. In this case, the second serving cell (e.g., RAN node 120B) may be using the same one or more beams used by the first serving cell. This determination may be made based on the configuration of CN 140. At 308, RAN node 120A may perform this determination.

At 310, RAN node 120A may determine that the second serving cell is not in a CBM band pair with the first serving cell. In this case, the second serving cell may be in an independent beam management (IBM) band pair with the first serving cell. In this case, while the second serving cell may be servicing UE 110, it may be using different beams from the first serving cell, which is current and active for RSSI measurement. In this case, at 310, RAN node 120A may not apply the scheduling restriction to the second serving cell. In some aspects, another node on network CN 140 may perform this determination.

At 312, if RAN node 120A determines that the second serving cell is in a CBM band pair, RAN node 120A may apply the scheduling restriction to the second serving cell to prevent the second serving cell from transmitting data on a data channel and a control channel of the second serving cell during the time window allocated for RSSI measurement. In some aspects, the scheduling restriction applied to RAN node 120A may also be applied to RAN node 120B. This may occur because the beams are commonly shared. The time allocated for RSSI measurement at RAN node 120A may also be allocated for RAN node 120B. This scheduling restriction may aid in avoiding collisions of data and/or avoid a situation where a RAN node 120 attempts to transmit data while UE 110 is performing a RSSI measurement.

FIG. 3C illustrates a flowchart 300C for determining a measurement prioritization when beam sweeping is used to determine a RSSI measurement, according to some aspects. In some aspects, CN 140 and/or one or more RAN nodes 120 may execute flowchart 300C. For example, RAN nodes 120A, 120B may execute flowchart 300C. In some aspects, application server 150 and/or CN 140 may operate with RAN nodes 120A, 120B to execute flowchart 300C. Flowchart 300C shall be described with reference to RAN nodes 120A and 120B; however, flowchart 300C is not limited to that example aspect. Flowchart 300C may be implemented by processor 165 (FIG. 1B). For example, processor 165 may execute instructions, stored in memory 185, to perform the functions described in flowchart 300C. Alternatively, processor 165 may be “hard-coded” to perform these functions. Additionally, flowchart 300C may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3C, as will be understood by a person of ordinary skill in the art.

Flowchart 300C will herein be described with reference to measurement prioritization at a RAN node 120A While a single RAN node 120A may be described, the measurement prioritization may similarly occur at multiple different RAN nodes 120A, 120B. For example, the first time window allocated for the RSSI measurement may occur at RAN node 120A. The second time window corresponding to a layer measurement window may occur at RAN node 120B. In some aspects, RAN nodes 120A, 120B may be CBM band pairs. In this case, the measurement prioritization may apply across multiple serving cells or RAN nodes 120.

At 320, a connection with a UE 110 may be established via an active serving cell used to perform RSSI measurement. Similar to 302 described with reference to FIG. 3B, this active serving cell may be RAN node 120A. The connection may be established in a similar manner.

At 322, RAN node 120A may identify a first time window allocated for RSSI measurement. This first time window may be similar to the time window allocated for RSSI measurement described with reference to FIG. 3B. This time window may provide time for UE 110 to perform the RSSI measurement.

At 324, RAN node 120A may identify a second time window corresponding to a layer measurement window for a Layer 1 (L1) or Layer 3 (L3) measurement. In some aspects, the L3 measurement may be a L3 downlink reference signal (DL RS) measurement. A L1 measurement may refer to measurements performed a physical layer. L1 measurements may be useful for procedures that require reaction with minimal delay. For example, L1 measurements may include beam management procedures. These procedures may include UE 110 rapidly switching between beams. In this manner, L1 measurements may be at a beam level.

L3 measurements may be used to make radio resource management decisions. These measurements may reflect more of a long term view of channel conditions. For example, RAN node 120A may trigger handover procedures after L3 filtering. This may reduce the risk of a ping-pong between serving cells. L3 filtering on corresponding measurement may lessen or remove the impact of fast fading and/or may help reduce short term variations in results. L3 measurements may be beam level and/or cell level. The measurements may be reported by UE 110 within an Radio Resource Control (RRC) message. In some aspects, beam level measurements may be generated from L1 measurements by applying L3 filtering. In some aspects, cell level measurements may be derived from L1 measurements based on preset rules.

For either L1 or L3 measurements, RAN node 120A may determine a second time window allocated for either L1 or L3 measurements at 324. This measurement may reflect a time allocated for the UE 110 to perform and/or report the L1 or L3 measurement.

At 326, RAN node 120A may determine that the first time window overlaps with the second time window. Examples of this overlap are further described with reference to FIGS. 4A and 4B. Because on the overlap, the RSSI measurement may collide with a L1 or L3 measurement. To avoid this collision, at 328, RAN node 120A may schedule the first time window for RSSI measurement to follow the second time window corresponding to the layer measurement window. In this case, RAN node 120A may prioritize the L3 measurement and/or the L1 measurement. As previously explained, the L3 measurement may be a L3 DL RS measurement. The RSSI measurement may follow the beam used for the L3 DL RS measurement. Based on this scheduling, collision may be avoided between RSSI measurement windows and layer measurement windows.

FIG. 3D illustrates a flowchart 300D for determining measurement prioritization based on periodicity when beam sweeping is used to determine a RSSI measurement, according to some aspects. In some aspects, CN 140 and/or one or more RAN nodes 120 may execute flowchart 300C. For example, RAN nodes 120A, 120B may execute flowchart 300C. In some aspects, application server 150 and/or CN 140 may operate with RAN nodes 120A, 120B to execute flowchart 300D. Flowchart 300D shall be described with reference to RAN nodes 120A and 120B; however, flowchart 300D is not limited to that example aspect. Flowchart 300D may be implemented by processor 165 (FIG. 1B). For example, processor 165 may execute instructions, stored in memory 185, to perform the functions described in flowchart 300D. Alternatively, processor 165 may be “hard-coded” to perform these functions. Additionally, flowchart 300D may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3D, as will be understood by a person of ordinary skill in the art.

Flowchart 300D will herein be described with reference to measurement prioritization at a RAN node 120A. While a single RAN node 120A may be described, the measurement prioritization may similarly occur at multiple different RAN nodes 120A, 120B. For example, the first time window allocated for the RSSI measurement may occur at RAN node 120A. The second time window corresponding to a layer measurement window may occur at RAN node 120B. In some aspects, RAN nodes 120A, 120B may be CBM band pairs. In this case, the measurement prioritization may apply across multiple serving cells or RAN nodes 120.

In some aspects, flowchart 300D may be similar to flowchart 300C except for the use of one or more periodicities to determine measurement prioritization. For example, at 330, a connection with a UE 110 may be established via an active serving cell used to perform RSSI measurement. This may occur in a manner similar to 320 described with reference to FIG. 3C. At 332, RAN node 120A may identify a first time window allocated for RSSI measurement. This may occur in a manner similar to 322 described with reference to FIG. 3C. At 334, RAN node 120A may identify a second time window corresponding to a layer measurement window for a Layer 1 (L1) or Layer 3 (L3) measurement. This may occur in a manner similar to 324 described with reference to FIG. 3C. At 336, RAN node 120A may determine that the first time window overlaps with the second time window. This may occur in a manner similar to 326 described with reference to FIG. 3C.

At 338, RAN node 120A may compare a periodicity of the first time window to a periodicity of the second time window. RAN node 120A may determine the periodicities based on a configuration from CN 140. The periodicity of the first time window may reflect a frequency of how often an RSSI measurement is performed. The periodicity of the second time window may reflect a frequency of how often a L1 or L3 measurement is performed. The periodicity may corresponding to the measurement windows and how often the measurement windows reoccur. In some aspects, the periodicity of the first time window may differ from the periodicity of the second time window. For example, the periodicities of the first time window may be greater than or less than the periodicity of the second time window. These differences in periodicity are further described with reference to FIGS. 4A and 4B. RAN node 120A may compare the periodicities at 338.

At 340, RAN node 120A may determine whether the periodicity of the first time window is less than the periodicity of the second time window. In some aspects, RAN node 120A may determine whether the periodicity of the second time window is less than the periodicity of the first time window. If the periodicity of the first time window is less, then the periodicity of the RSSI measurement window may be less than the periodicity of the L1 or L3 measurement. In this case, RAN node 120A may, at 344, transmit an instruction to the UE to perform an RSSI measurement on a non-overlapped instance of the first time window allocated for RSSI measurement.

To illustrate an example of this measurement, FIG. 4A depicts an example difference in periodicity. FIG. 4A illustrates a block diagram 400A of overlapping periodicities with an RSSI window having a lower periodicity, according to some aspects. Sequence 410 may depict time windows 412, 414, 416 corresponding to RSSI measurement windows. Sequence 420 may depict time windows 422, 424 corresponding to L1 or L3 measurement windows. As seen from block diagram 400A, the period of time windows 412, 414, 416 is less than that of time windows 422, 424. In this manner, the periodicity corresponding to the RSSI measurement windows may be lower. Returning to 344, in view of this difference, RAN node 120 may transmit an instruction to the UE 110 to perform an RSSI measurement during a non-overlapped instance of the first time window allocated for RSSI measurement. In the context of FIG. 4A, this may occur at time window 414. This occurs because time windows 412 and 416 overlap with time windows 422 and 424 respectively. To avoid collisions, UE 110 may perform the RSSI measurement during a non-overlapping instance of the first time window.

At 342, if the periodicity of the first time window is not less than the periodicity of the second window, RAN node 120A may transmit an instruction to the UE to perform a layer measurement on a non-overlapped instance of the second time window. This may occur when the periodicity of the second time window corresponding to a L or L3 measurement is less than the periodicity of the RSSI measurement window.

To illustrate an example of this measurement, FIG. 4B depicts an example difference in periodicity. FIG. 4B illustrates a block diagram 400B of overlapping periodicities with a layer measurement window having a lower periodicity, according to some aspects. Sequence 430 may depict time windows 432, 434 corresponding to RSSI measurement windows. Sequence 440 may depict time windows 442, 444, 446 corresponding to L1 or L3 measurement windows. As seen from block diagram 400B, the period of time windows 442, 444, 446 is less than that of time windows 432, 434. In this manner, the periodicity corresponding to the L1 or L3 measurement windows may be lower. Returning to 342, in view of this difference, RAN node 120 may transmit an instruction to the UE 110 to perform a layer measurement during a non-overlapped instance of the second time window allocated for layer measurement. In the context of FIG. 4B, this may occur at time window 444. This occurs because time windows 442 and 446 overlap with time windows 432 and 434 respectively. To avoid collisions, UE 110 may perform the layer measurement during a non-overlapping instance of the second time window.

FIG. 3E illustrates a flowchart 300E for determining measurement prioritization with matching periodicity when beam sweeping is used to determine a RSSI measurement, according to some aspects. In some aspects, CN 140 and/or one or more RAN nodes 120 may execute flowchart 300E. For example, RAN nodes 120A, 120B may execute flowchart 300E. In some aspects, application server 150 and/or CN 140 may operate with RAN nodes 120A, 120B to execute flowchart 300E. Flowchart 300E shall be described with reference to RAN nodes 120A and 120B; however, flowchart 300E is not limited to that example aspect. Flowchart 300E may be implemented by processor 165 (FIG. 1B). For example, processor 165 may execute instructions, stored in memory 185, to perform the functions described in flowchart 300E. Alternatively, processor 165 may be “hard-coded” to perform these functions. Additionally, Flowchart 300E may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3E, as will be understood by a person of ordinary skill in the art.

Flowchart 300E will herein be described with reference to measurement prioritization at a RAN node 120A. While a single RAN node 120A may be described, the measurement prioritization may similarly occur at multiple different RAN nodes 120A, 120B. For example, the first time window allocated for the RSSI measurement may occur at RAN node 120A. The second time window corresponding to a layer measurement window may occur at RAN node 120B. In some aspects, RAN nodes 120A, 120B may be CBM band pairs. In this case, the measurement prioritization may apply across multiple serving cells or RAN nodes 120.

In some aspects, flowchart 300E may be similar to flowcharts 300C and 300D except for the identification of a matching periodicity corresponding to measurement prioritization. For example, at 350, a connection with a UE 110 may be established via an active serving cell used to perform RSSI measurement. This may occur in a manner similar to 320 described with reference to FIG. 3C. At 352, RAN node 120A may identify a first time window allocated for RSSI measurement. This may occur in a manner similar to 322 described with reference to FIG. 3C. At 354, RAN node 120A may identify a second time window corresponding to a layer measurement window for a Layer 1 (L1) or Layer 3 (L3) measurement. This may occur in a manner similar to 324 described with reference to FIG. 3C. At 356, RAN node 120A may determine that the first time window overlaps with the second time window. This may occur in a manner similar to 326 described with reference to FIG. 3C. At 358, RAN node 120A may compare a periodicity of the first time window a periodicity of the second time window. This may occur in a manner similar to 338 described with reference to FIG. 3D.

At 360, RAN node 120A may determine that the periodicity of the first time window matches the periodicity of the second time window. In the case of matching periodicity, the RSSI measurement windows may fully overlap with L1 or L3 measurement windows. An example of this overlap is depicted in FIG. 4C.

FIG. 4C illustrates a block diagram 400C of matching periodicities, according to some aspects. Sequence 450 may depict time windows 452, 454, 456 corresponding to RSSI measurement windows. Sequence 460 may depict time windows 462, 464, 466 corresponding to L1 or L3 measurement windows. As seen from block diagram 400C, the period of time windows 452, 454, 456 may match the period of time windows 462, 464, 466. In this manner, the periodicity of the RSSI measurements windows may match the periodicity of the L1 or L3 measurement windows. Returning to 360, in view of this overlap, RAN node 120 may determine that the periodicities match.

At 362, UE 110 may perform an RSSI measurement using a proportion of a plurality of overlapping first and second time windows. In some aspects, RAN node 120 may transmit an instruction to UE 110 to cause the UE to perform this measurement. In some aspects, UE 110 may store executable instructions and/or software in memory instructing processor 165 to identify the portion of overlapping first and second time windows to use for an RSSI measurement. In some aspects, the proportion allocated to the RSSI measurement may be less than the proportion allocated to the L1 or L3 measurements. For example, when considering three overlapping time windows, UE 110 may perform an RSSI measurement on one of the overlapping time windows while performing an L1 or L3 measurement on the other two overlapping time windows. In the context of FIG. 4C, UE 110 may, for example, perform an RSSI measurement at time window 454 while performing an L1 or L3 measurement at time windows 462 and 466. This process may prioritize L1 or L3 measurements over RSSI measurements.

In some aspects, the proportion allocated to the RSSI measurement may be greater than the proportion allocated to the L1 or L3 measurements. For example, when considering three overlapping time windows, UE 110 may perform an RSSI measurement on two of the overlapping time windows while performing an L1 or L3 measurement on the other one overlapping time window. In the context of FIG. 4C. UE 110 may, for example, perform an RSSI measurement at time windows 452, 456 while performing an L1 or L3 measurement at time window 464. This process may prioritize RSSI measurements over L1 or L3 measurements.

Based on the prioritization instructed at 362, UE 110 may be instructed to avoid collisions between difference measurements while still using beam sweeping.

FIG. 5 illustrates a flowchart 500 for beam selection to determine a RSSI measurement at a UE, according to some aspects. In some aspects, UE 110 may execute flowchart 500. Flowchart 500 shall be described with reference to UE 110; however, flowchart 500 is not limited to that example aspect. Flowchart 500 may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5, as will be understood by a person of ordinary skill in the art.

At 502, UE 110 may be configured to perform beam to measure received signal strength indicator (RSSI) samples by selecting one or more received beams. For example, a processor 165 in UE 110 may be configured to perform a beam selection process to analyze received beams. This configuration may occur according to a predefined communications standard. Similarly, the predefined communications standard may specify which one or more beams to select. The UE 110 may be preprogrammed to perform the beam selection process. Memory 185 may store executable instructions and/or software instructing processor 165 to use the beam selection process and/or which one or more beams to select. In some aspects, a RAN node 120 may transmit a configuration instruction to UE 110 to configure UE 110 to perform the beam selection process. For example, the configuration instruction may provide and/or activate programming in UE 110 to perform the beam selection process to determine an RSSI measurement.

To perform the beam selection process, UE 110 may select one or more local received beams 115A, 115B, 115C from a serving component carrier (CC). Local received beams 115A, 115B, 115C may correspond to beams 125A transmitted from a RAN node 120A, which may be transmitted in predefined directions. In some aspects, UE 110 may select one or more of the local received beams 115 for the RSSI measurement. In some aspects. UE 110 may select a beam corresponding to a data or control channel reception for a particular symbol or slot. In some aspects, UE 110 may select a beam for a L1 or L3 DL RS measurement for a particular symbol or slot. In some aspects, UE 110 may select a beam corresponding to a priority signal or channel reception for a particular symbol or slot. The priority signal or channel reception may be the highest priority. For example, the highest priority may indicate that if on one symbol or slot, a data channel, a control channel, or a DL RS are colliding, the highest priority channel or signal may be the reference to determine the beam to select.

In some aspects, UE 110 may not receive DL RS, control channel, or data channel reception for a particular symbol or slot. In this case, UE 110 may select a random beam for RSSI measurement. In some aspects, UE 110 may select a beam previously used for an RSSI measurement for the symbol or slot. In some aspects. UE 110 may select a beam based on a current active transmission configuration indicator (TCI) for the data or control channel. In some aspects, UE 110 may select a beam based on an on-use active TCI for received data. In some aspects, the one or more beams selected by UE 110 may include a data channel reception beam, a control channel reception beam, an active TCI beam, an on-use active TC beam corresponding to a data channel, a highest priority signal, or a channel reception beam. In some aspects, the selected one or more beams may include a downlink reference signal beam. In some aspects, the selected one or more beams may include a random beam or a beam previously used for RSSI measurement.

At 504, UE 110 may receive a plurality of beams from a Radio Access Network (RAN) node 120. For example, UE 110 may be communicating with RAN node 120A, which may service a target serving cell where the RSSI measurement is performed. In some aspects, UE 110 may receive multiple pluralities of beams 125A, 125B from multiple RAN nodes 120. For example, UE 110 may receive beams 125A, 125B from RAN nodes 120A and 120B. Using beam selection, UE 110 may analyze these received beams 125A, 125B.

At 506, UE 110 may select one or more beams from the plurality of beams for sampling. This selection may occur based on the configuration of 502. At 508, UE 110 may sample the one or more beams selected to generate RSSI samples. UE 110 may perform this sampling in a manner similar to the sampling described with reference to 206 of FIG. 2. The sampling may apply to the selected one or more beams. At 510, UE 110 may calculate an average RSSI measurement based on the RSSI samples from the one or more beams selected. UE 110 may perform this calculation in a manner similar to the sampling described with reference to 208 of FIG. 2.

For the selected one or more beams, UE 110 may calculate one or more RSSI measurement results. The average RSSI measurement may be a single value or may be multiple values corresponding to the selected beams. In some aspects, the calculated average RSSI measurement may depend on the configuration performed at 502. This calculated average may be preconfigured at UE 110 and/or may be requested by a RAN node 120. In some aspects, the calculated average may be determined by performing Layer 1 (L1) filtering on the RSSI samples.

In some aspects, the calculated average may be determined across the selected one or more beams 115. For example, UE 110 may calculate an RSSI measurement by averaging the samples across the selected one or more beams 115. If a one shot RSSI measurement is used, UE 110 may identify the single RSSI sample measured for each selected beam and then average together or L1 filter the samples from each beam.

In some aspects, the RSSI measurement may be multiple values corresponding to calculated averages from RSSI samples received on the different selected beams 115A, 115B. For example, UE 110 may calculate a first RSSI measurement for beam 115A based on RSSI samples received on beam 115A. UE 110 may calculate a second RSSI measurement for beam 115B based on RSSI samples received on beam 115B. If a one shot RSSI measurement is used, the calculated average for each beam 115A, 115B may be the single RSSI sample measured for each selected beam

At 512, UE 110 may transmit the average RSSI measurement to a RAN node 120. This may occur in a manner similar to the reporting described with reference to 210 of FIG. 2. For example, the calculated average RSSI measurement may depend on the configuration specified at 502. In some aspects. UE 110 may report a single RSSI measurement result. This result may correspond to averaging the RSSI beam samples from the selected one or more beams. In some aspects. UE 110 may report multiple RSSI measurement results corresponding to the selected one or more beams. For example, UE 110 may report a RSSI measurement for beam 115A and/or another RSSI measurement for beam 1115B. In some aspects, UE 110 may report a corresponding beam number and/or identification corresponding to each RSSI measurement. These RSSI measurements may occur for each of the beams transmitted by RAN node 120 and/or may be a subset of the beams transmitted.

Based on the reported RSSI measurements, RAN nodes 120 may determine cell selection for UE 110. To aid with this determination, as previously explained at 502, one or more RAN nodes 120 may transmit configuration instructions to UE 110 to indicate the type of sampling to perform, the type of average RSSI measurement to calculate, and/or the type of RSSI measurement results to report. For example, in the RSSI mobile originating configuration, the RAN node 120 may configure the RSSI measurement to use beam selection. The RAN node 120 may instruct UE 110 to perform averaging or L1 filtering for each selected beam. In some aspects, the RAN node 120 may instruct UE 110 to perform averaging or L1 filtering based on the selected beams.

RAN nodes 120 may also instruct a UE 110 to report one or more RSSI measurements. For example, UE 110 may be instructed to provide a single RSSI measurement result. In some aspects, UE 110 may be instructed to report individual RSSI measurement results corresponding to one or more beams or for each beam. In some aspects, UE 110 may be instructed to use a threshold to determine which RSSI measurement results to report. For example, UE 110 may report RSSI measurements exceeding the threshold and/or corresponding beam identifications. In some aspects, UE 110 may report one reference RSSI measurement result and delta values of other RSSI measurement results compared to the reported one reference RSSI measurement.

When using beam selection at UE 110 on a serving CC, RAN node 120A may not require a scheduling restriction and/or a measurement restriction. These restrictions may be avoiding because the selected beams for RSSI measurement would be applied to the target serving cell and/or another active serving cell. This may avoid the situation where UE 110 samples different beams like in the beam sweeping case. For non-serving CC, UE 110 may still use beam sweeping and/or an indicated beam for RSSI measurement. This indicated beam case is further described with reference to FIG. 6.

FIG. 6 illustrates a flowchart 600 for beam indication to determine a RSSI measurement at a UE, according to some aspects. In some aspects, UE 110 may execute flowchart 600. Flowchart 600 shall be described with reference to UE 110; however, flowchart 600 is not limited to that example aspect. Flowchart 600 may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 6, as will be understood by a person of ordinary skill in the art.

At 602, UE 110 may receive an instruction from a RAN node 120A indicating one or more beams for measuring received signal strength indicator (RSSI) samples. At 604, UE 110 may be configured to measure RSSI samples from the one or more beams indicated by the RAN node 120A. In this configuration, UE 110 may be configured to follow a network configuration of an associated RS or TC or beam to perform the RSSI measurement. The associated RS may be a DL RS or an uplink (UL) RS. In this case, UE 110 may use the received beam associated with the DL RS or the UL RS. In some aspects, the TCI may be active or inactive. In this case, UE 110 may use a received beam associated with the TCI. By using one or more of these beams. UE 110 may follow and/or use the beams indicated by RAN node 120A to perform the RSSI measurement.

At 606, UE 110 may receive a plurality of beams from RAN node 120A. This may occur in a manner similar to 204 as described with reference to FIGS. 2 and/or 504 as described with reference to FIG. 5.

At 608, UE 110 may select the one or more beams indicated by the RAN node 120A from the plurality of beams for sampling. This selection may occur according to the beams indicated at 602. At 610, UE 110 may sample the one or more beams selected to generate RSSI samples. UE 110 may perform this sampling in a manner similar to the sampling described with reference to 206 of FIG. 2. The sampling may apply to the one or more beams indicated by RAN node 120A. At 612, UE 110 may calculate an average RSSI measurement based on the RSSI samples from the one or more beams indicated by RAN node 120A. UE 110 may perform this calculation in a manner similar to the sampling described with reference to 208 of FIG. 2.

For the indicated one or more beams, UE 110 may calculate one or more RSSI measurement results. In some aspects, the average RSSI measurement may be a single value or may be multiple values corresponding to each of the indicated beams. In some aspects, the calculated average RSSI measurement may depend on the configuration performed at 602. This calculated average may be preconfigured at UE 110 and/or may be requested by a RAN node 120. In some aspects, the calculated average may be determined by performing Layer 1 (L1) filtering on the RSSI samples.

In some aspects, the calculated average may be determined across the indicated beams 115. For example, UE 110 may calculate an RSSI measurement by averaging the samples across the indicated beams 115. If a one shot RSSI measurement is used, UE 110 may identify the single RSSI sample measured for each of the indicated beams and then average together or L1 filter the samples from each beam.

The RSSI measurement may be multiple values corresponding to calculated averages from RSSI samples received on different indicted beams 115A, 115B. For example, UE 110 may calculate a first RSSI measurement for beam 115A based on RSSI samples received on beam 115A. UE 110 may calculate a second RSSI measurement for beam 115B based on RSSI samples received on beam 115B. If a one shot RSSI measurement is used, the calculated average for each beam 115A, 115B may be the single RSSI sample measured for each indicated beam.

At 614, UE 110 may transmit the average RSSI measurement to a RAN node 120. This may occur in a manner similar to the reporting described with reference to 210 of FIG. 2. For example, the calculated average RSSI measurement may depend on the configuration specified at 602 and 604. In some aspects, UE 110 may report a single RSSI measurement result. This result may correspond to averaging the RSSI beam samples from the indicated one or more beams. In some aspects, UE 110 may report multiple RSSI measurement results corresponding to the indicated one or more beams. For example, UE 110 may report a RSSI measurement for beam 115A and/or another RSSI measurement for beam 115B. In some aspects, UE 110 may report a corresponding beam number and/or identification corresponding to each RSSI measurement. These RSSI measurements may occur for each of the beams transmitted by RAN node 120 and/or may be a subset of the beams transmitted.

Based on the reported RSSI measurements. RAN nodes 120 may determine cell selection for UE 110. To aid with this determination, as previously explained at 602, one or more RAN nodes 120 may transmit configuration instructions to UE 110 to indicate the type of sampling to perform, the type of average RSSI measurement to calculate, and/or the type of RSSI measurement results to report. For example, in the RSSI mobile originating configuration, the RAN node 120 may configure the RSSI measurement be based on indicated beams. The RAN node 120 may instruct UE 110 to perform averaging or L1 filtering for each indicated beam. In some aspects, the RAN node 120 may instruct UE 110 to perform averaging or L1 filtering based on the indicated beams.

RAN nodes 120 may also instruct a UE 110 to report one or more RSSI measurements. For example, UE 110 may be instructed to provide a single RSSI measurement result. In some aspects. UE 110 may be instructed to report individual RSSI measurement results corresponding to one or more beams or for each beam. In some aspects, UE 110 may be instructed to use a threshold to determine which RSSI measurement results to report. For example, UE 110 may report RSSI measurements exceeding the threshold and/or corresponding beam identifications. In some aspects, UE 110 may report one reference RSSI measurement result and delta values of other RSSI measurement results compared to the reported one reference RSSI measurement.

For the scenario where a RAN node 120A indicates one or more beams for RSSI measurement on a serving CC, the RAN node 120A may apply scheduling restrictions and/or measurement restrictions. These may be similar to those described with reference to FIGS. 3A to 3E. For example, for a target serving cell (e.g., RAN node 120A) that is the active serving cell where the RSSI measurement is performed, a scheduling restriction may be placed on the data and/or control channels during the RSSI measurement window of the target serving cell. This may help to avoid data collisions.

If there is another active serving cell (e.g., RAN node 120B) servicing UE 110, RAN node 120A may determine whether the other active serving cell is in a CBM band pair with the target active serving cell (e.g., RAN node 120A). If so, the same scheduling restriction may be applied to the other active serving cell. If the other active serving cell is in an IBM band pair with the target active serving cell, a scheduling restriction may not be applied to the other active serving cell.

In some aspects, if an indicated beam is the same as the target serving cell's data or control channel, no scheduling restriction may be applied to the target serving cell. Similarly, if an indicated beam is the same as the other active serving cell's data or control channel, no scheduling restriction may be applied to the other active serving cell. No scheduling restriction may be needed because collisions may be avoided.

For measurement restrictions, if an indicated beam is different from a beam used for another L1 or L3 measurement, RAN node 120A may use the techniques described with reference to FIGS. 3C to 3E. This may avoid collisions by prioritizing RSSI measurements with L1 or L3 measurements. If an indicated beam is the same as a beam used for another L1 or L3 measurement, no measurement restriction needs to be applied for the other L1 or L3 measurements.

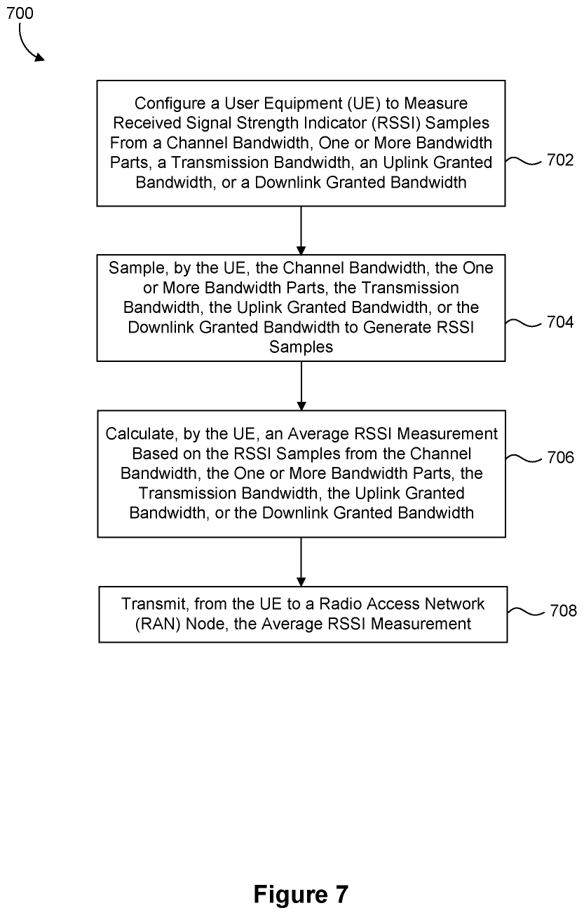

FIG. 7 illustrates a flowchart 700 for using a frequency domain resource to determine a RSSI measurement at a UE, according to some aspects. In some aspects, UE 110 may execute flowchart 700. Flowchart 700 shall be described with reference to UE 110; however, flowchart 700 is not limited to that example aspect. Flowchart 700 may be executed on any computing device, such as, for example, the computer system described with reference to FIG. 8 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 7, as will be understood by a person of ordinary skill in the art.

At 702, UE 110 may be configured to measure received signal strength indicator (RSSI) samples from a channel bandwidth, one or more bandwidth parts, a transmission bandwidth, a uplink granted bandwidth, or a downlink granted bandwidth. For example, a processor 165 in UE 110 may be configured to use a frequency domain resource the RSSI measurement. This configuration may occur according to a predefined communications standard. For example, UE 110 may be preprogrammed to use frequency domain resources. In some aspects, a RAN node 120 may transmit a configuration instruction to UE 110 to configure UE 110 to use frequency domain resources to perform an RSSI measurement. For example, the configuration instruction may provide and/or activate programming in UE 110 to use frequency domain resources to determine an RSSI measurement.

In some aspects, UE 110 may use a channel bandwidth to perform the RSSI measurement. In some aspects, UE 110 may use an active bandwidth part to perform the RSSI measurement. In some aspects, UE 110 may use a bandwidth part that may not be active but may be configured to perform a RSSI measurement. In this case, UE 110 may choose a bandwidth part to perform a RSSI measurement. UE 110 may randomly choose this bandwidth part. UE 110 may or may not report the RSSI measurement result with a corresponding bandwidth part index. This index may identify the bandwidth part. In some aspects. UE 110 may use one or more candidate bandwidth parts to perform RSSI measurement. For example, UE 110 may determine a RSSI measurement for each bandwidth part. UE 110 may or may not report the RSSI measurement with a bandwidth part index.

In some aspects, UE 110 may use its transmission bandwidth to perform the RSSI measurement. This transmission bandwidth may extend from the lowest resource block to the highest resource block used for transmission. In some aspects, UE 110 may use its uplink granted bandwidth or its downlink granted bandwidth to perform the RSSI measurement. In some aspects, UE 110 may use one or more predefined bandwidths within a channel bandwidth to perform the RSSI measurement.

As previously explained, UE 110 may be preconfigured to use one of these bandwidth or bandwidth parts to perform the RSSI measurement. In some aspects, RAN node 120A may transmit configuration instructions and/or frequency domain information to UE 110 to perform this type of RSSI measurement. For example, RAN node 120A may configure UE 110 to use one of the aforementioned bandwidths and/or bandwidth parts. In some aspects, RAN node 120A may configure bandwidth used for the RSSI measurement. For example, RAN node 120A may configure the bandwidth size and/or the bandwidth position in the frequency domain. In some aspects, RAN node 120A may indicate one or more bandwidth parts for use by UE 110 to perform an RSSI measurement.

At 704, UE 110 may sample the channel bandwidth, the one or more bandwidth parts, the transmission bandwidth, the uplink granted bandwidth, or the downlink granted bandwidth to generate RSSI samples. This sampling may occur according to the configuration identified in 702. For example, RAN node 120A may specify the channel bandwidth or the one or more bandwidth parts for UE 110 to sample. In some aspects, this sampling may occur in a manner similar to 206 as described with reference to FIG. 2.

At 706, UE 110 may calculate an average RSSI measurement based on the RSSI samples from the channel bandwidth, the one or more bandwidth parts, the transmission bandwidth, the uplink granted bandwidth, or the downlink granted bandwidth. This calculation may occur in a manner similar to 208 as described with reference to FIG. 2.

At 708, UE 110 may transmit the average RSSI measurement to RAN node 120A. This reporting may be similar to 210 as described with reference to FIG. 2. In some aspects, RAN node 120A may specify the type of RSSI measurement desired. Using the received RSSI measurement, RAN node 120A may determine a cell for servicing UE 110.

FIG. 8 depicts an example computer system useful for implementing various aspects. Various aspects may be implemented, for example, using one or more well-known computer systems, such as computer system 800 shown in FIG. 8. One or more computer systems 800 may be used, for example, to implement any of the aspects discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise”cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 8. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

1. A method, comprising:
configuring a user equipment (UE) to perform beam sweeping to measure received signal strength indicator (RSSI) samples;
receiving, at the UE, a plurality of beams from a Radio Access Network (RAN) node;
sampling, by the UE, the plurality of beams according to the beam sweeping to generate RSSI samples;
calculating, by the UE, an average RSSI measurement based on the RSSI samples from the beam sweeping; and
transmitting, from the UE to the RAN node, the average RSSI measurement.

2. The method of claim 1, wherein the configuring further comprises:
receiving, at the UE, a configuration instruction from the RAN node to use the beam sweeping to generate the RSSI samples.

3. The method of claim 1, wherein the average RSSI measurement is a single RSSI measurement for the plurality of beams.

4. The method of claim 1, wherein the average RSSI measurement comprises respective RSSI measurements for at least two of the plurality of beams.

5. The method of claim 4, wherein the average RSSI measurement comprises respective RSSI measurements that exceed a predefined threshold.

6. The method of claim 1, wherein the plurality of beams includes a beam having a frequency between or above 52.6 GHz to 71 GHz.

7. A method, comprising:
establishing, at a Radio Access Network (RAN) node, a connection with a user equipment (UE) to receive a received signal strength indicator (RSSI) measurement;
applying a scheduling restriction or a measurement restriction to communications with the UE to allocate a time window for the RSSI measurement, wherein applying the scheduling restriction comprises:
establishing a connection with the UE via a first serving cell serviced by the RAN node and a second serving cell;
applying the scheduling restriction on transmitting data on a data channel and a control channel of the first serving cell during the time window allocated for the RSSI measurement;
determining that the second serving cell is in a common beam management (CBM) band pair with the first serving cell or is in a same band as the first serving cell; and
applying the scheduling restriction to the second serving cell to prevent the second serving cell from transmitting data on a data channel and a control channel of the second serving cell during the time window allocated for RSSI measurement; and
receiving, from the UE, the RSSI measurement.

8. The method of claim 7, wherein applying the measurement restriction further comprises:
identifying a first time window allocated for RSSI measurement at the UE;
identifying a second time window corresponding to a layer measurement window for a Layer 1 (L1) or Layer 3 (L3) measurement;
determining that the first time window overlaps with the second time window; and
scheduling the first time window allocated for RSSI measurement to follow the second time window corresponding to the layer measurement window.

9. The method of claim 7, wherein applying the measurement restriction further comprises:
identifying a first time window allocated for RSSI measurement at the UE;
identifying a second time window corresponding to a layer measurement window for a Layer 1 (L1) or Layer 3 (L3) measurement;
determining that the first time window overlaps with the second time window;
comparing a periodicity of the first time window to a periodicity of the second time window;
determining that the periodicity of the first time window is less than the periodicity of the second time window; and
transmitting, from the RAN node to the UE, an instruction to perform an RSSI measurement during a non-overlapped instance of the first time window allocated for RSSI measurement.

10. The method of claim 7, wherein applying the measurement restriction further comprises:
identifying a first time window allocated for RSSI measurement at the UE;
identifying a second time window corresponding to a layer measurement window for a Layer 1 (L1) or Layer 3 (L3) measurement;
determining that the first time window overlaps with the second time window;
comparing a periodicity of the first time window to a periodicity of the second time window;
determining that the periodicity of the second time window is less than the periodicity of the first time window; and
transmitting, from the RAN node to the UE, an instruction to perform a layer measurement during a non-overlapped instance of the second time window.

11. The method of claim 7, wherein applying the measurement restriction further comprises:
identifying a first time window allocated for RSSI measurement at the UE;
identifying a second time window corresponding to a layer measurement window for a Layer 1 (L1) or Layer 3 (L3) measurement;
determining that the first time window overlaps with the second time window;
comparing a periodicity of the first time window to a periodicity of the second time window;
determining that the periodicity of the first time window matches the periodicity of the second time window; and
causing the UE to perform an RSSI measurement using a proportion of a plurality of overlapping first and second time windows.

12. The method of claim 11, wherein the proportion of overlapping first and second time windows allocated for RSSI measurement is less than a proportion of overlapping first and second time windows allocated for layer measurement.

13. The method of claim 11, wherein the proportion of overlapping first and second time windows allocated for RSSI measurement is greater than a proportion of overlapping first and second time windows allocated for layer measurement.

14. (canceled)

15. A wireless communication apparatus, comprising:
a transceiver; and
at least one processor coupled to the transceiver, wherein the at least one processor is configured to:
receive a plurality of beams from a Radio Access Network (RAN) node;
select one or more beams from the plurality of beams for sampling;
sample the one or more beams selected to generate received signal strength indicator (RSSI) samples;
calculate an average RSSI measurement based on the RSSI samples from the one or more beams selected; and
transmit, to the RAN node, the average RSSI measurement.

16. The wireless communication apparatus of claim 15, wherein the at least one processor is further configured to:
configure the wireless communication apparatus according to instructions stored in a memory device of the wireless communication apparatus to use a beam selection process to identify a subset of beams from the plurality of beams for sampling.

17. The wireless communication apparatus of claim 15, wherein the selected one or more beams include a data channel reception beam, a control channel reception beam, an active TCI beam, an on-use active TCI beam corresponding to a data channel, a highest priority signal, or a channel reception beam.

18. The wireless communication apparatus of claim 15, wherein the selected one or more beams include a downlink reference signal beam.

19. The wireless communication apparatus of claim 15, wherein the selected one or more beams include a random beam or a beam previously used for RSSI measurement.

20.-24. (canceled)

25. The wireless communication apparatus of claim 15, wherein the at least one processor is further configured to:
receive an instruction from the RAN node indicating one or more beams for measuring RSSI samples; and
calculate the average RSSI measurement based on the one or more beams indicated by the RAN node.

26. The wireless communication apparatus of claim 15, wherein the at least one processor is further configured to:
sample a channel bandwidth, one or more bandwidth parts, a transmission bandwidth, an uplink granted bandwidth, or a downlink granted bandwidth to generate the RSSI samples.
